(19) United States
(12) Patent Application Publication
(10) Pub. No.: US 2013/0222583 A1
(43) Pub. Date: Aug. 29, 2013

(54) System and Method for Obtaining Images from External Cameras Using a Mobile Device

(71) Applicant: Andrew Mark Earnshaw, Kanata (CA)

(72) Inventor: Andrew Mark Earnshaw, Kanata (CA)

(73) Assignee: RESEARCH IN MOTION LIMITED

(21) Appl. No.: 13/634,643

(22) PCT Filed: Feb. 28, 2012
(86) PCT No.: PCT/CA2012/050119

§ 371 Date: Sep. 13, 2012

(51) Int. Cl. H04N 7/18

(52) U.S. Cl. CPC H04N 7/18
USPC 348/143

(57) ABSTRACT

A method is provided for a mobile device to obtain an image from an external camera. The mobile device obtains synchronization data from a server. When a user sees an image that he or she would like to capture using the external camera, the user hits or selects a button or key on the mobile device, designated for selecting an image, to take a picture of the image. The mobile device receives a user input to indicate the image desired to be obtained. The mobile device generates a time stamp marking when the user input was received. The time stamp is generated using the synchronization data. It then sends an image request to the server, which includes the time stamp. The server, which stores the images from the external camera, sends the requested image to the mobile device.

### TECHNICAL FIELD

The following relates generally to obtaining an image from an external camera using a mobile device.

### DESCRIPTION OF THE RELATED ART

In some public venues there are cameras mounted to capture images, such as pictures and video. In some situations, these images can be made available to certain people. For example, in a theme park or amusement park, there are cameras mounted facing a roller coaster to capture images of people riding the roller coaster. After the ride, the people manually select and purchase the pictures or video segments of themselves from a vendor booth. The vendor booth is equipped with display screens showing the various captured images, which can be purchased. The vendor prints out the pictures and provides a CD or DVD of the video for the customer. In some cases, the vendor emails the pictures or video to the customer.

### BRIEF DESCRIPTION OF THE DRAWINGS

Example embodiments will now be described by way of example only with reference to the appended drawings wherein:

FIG. 1 is a schematic diagram of an example embodiment system for obtaining images captured by external cameras using a mobile device.

FIG. 2 is a block diagram of an example embodiment server.

FIG. 3 is a plan view of an example embodiment mobile device.

FIG. 4 is a plan view of another example embodiment mobile device.

FIG. 5 is a plan view of another example embodiment mobile device.

FIG. 6 is a block diagram of an example embodiment of a mobile device.

FIG. 7 is a screen shot of a home screen displayed by the mobile device, according to an example embodiment.

FIG. 8 is a block diagram illustrating example embodiments of the other software applications and components shown in FIG. 6.

FIG. 9 is a flow diagram of example embodiment computer executable or processor implemented instructions for streaming low resolution images and obtaining a high resolution image.

FIG. 10 is a flow diagram of example embodiment computer executable or processor implemented instructions for obtaining an image.

FIG. 11 is a flow diagram of example embodiment computer executable or processor implemented instructions for obtaining an image, continued from FIG. 10 or FIG. 13.

FIG. 12 is a flow diagram of example embodiment computer executable or processor implemented instructions for obtaining an image, continued from FIG. 10 or FIG. 13.

FIG. 13 is a flow diagram of example embodiment computer executable or processor implemented instructions for obtaining an image.

FIG. 14 is a flow diagram of example embodiment computer executable or processor implemented instructions for deleting images from the server.

FIG. 15 is an example embodiment map showing the locations of external cameras and check points located within certain zones.

FIG. 16 is a flow diagram of example embodiment computer executable or processor implemented instructions for verifying the location of a mobile device within a zone.

FIG. 17 is a flow diagram of example embodiment computer executable or processor implemented instructions for verifying the location of a mobile device within a zone.

### DETAILED DESCRIPTION

It will be appreciated that for simplicity and clarity of illustration, where considered appropriate, reference numerals may be repeated among the example figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

In some public venues, many people may wish to take pictures or take video of events. For example, in an amusement park or theme park, people use their own cameras to capture images of other people riding a roller coaster. People also use their own cameras to take pictures and video at a marine park, which show whales and dolphins performing. People also use their own cameras to take pictures and video in sport stadiums during games and matches. Other examples of venues include race tracks and concerts.

The spectators in public venues, in many cases, are not positioned in locations that allow for good photography and videography. For example, they are positioned too low on the ground, or there are people or objects obstructing the view of their cameras. Additionally, the cameras belonging to the spectators can sometimes be of low quality (e.g. low zoom capabilities, low image quality, slow shutter speed, etc.). Furthermore, a spectator's camera may shake when attempting to capture an image, thus producing a blurred image.

Many public venue operators have installed high quality cameras throughout a public venue in locations that capture desired points of view. For example, cameras are installed facing a section of a roller coaster to capture images of people's faces while experiencing the ride. The cameras may be permanently mounted in a fixed position and orientation, or may have actuators allowing the camera to move. A vendor booth shows the captured images to customers, and the customers select the images for purchase. An attendant at the vendor booth then prints out the selected images or prepares the selected video to give to the customer. Such an operation requires an attendant to manage the sales. Furthermore, it requires a customer to visually search for their picture. It also takes away the user's ability or feeling of controlling the picture taking process, as usually present when a user takes a picture or video from their own camera.

The proposed example embodiments described herein allow a user to synchronize their mobile device with a server. The server transmits a stream of images to the mobile device. The stream of images are low-resolution images that correspond to higher resolution images captured by an external camera mounted in a public venue. The user provides a user input to the mobile device to “snap” an image during the streaming of the images. A time stamp of when the user input was provided, and the corresponding higher resolution image corresponding to the time stamp is transmitted to the mobile device. It can be appreciated that although some of the examples are described with respect to a roller coaster in an amusement park, other types of public venues are applicable to the principles described herein.

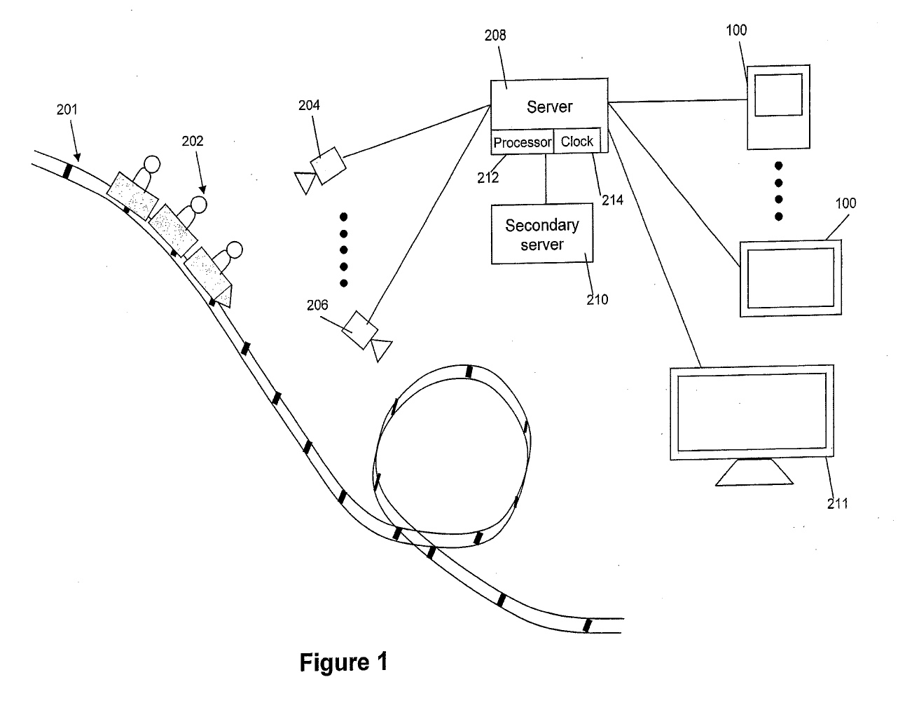

Turning to FIG. 1, cameras 204, 206 are mounted along different sections of a roller coaster 201 to take images of the people 202 riding the roller coaster. It can be appreciated that the number of cameras can vary. The cameras 204, 206 can be configured to continuously record images, such as photographs or video, or both. It can be appreciated that the term “images” herein generally refers to photographs and video data, which can be considered a compilation of still images. The cameras 204, 206 are in communication with a server 208. The images from the cameras 204, 206 are transmitted to the server 208 for storage. Each of the images is associated with a time stamp, indicating, for example, the time each image was captured. Each image may also be associated with a camera ID indicating the identity of the camera that captured the image.

The server 208 has a processor 212 and a clock 214. The clock 214, for example, is used to mark when the images were captured. The server 208 also has memory for storing images and software programs for managing the distribution of the images.

The server 208 is in communication with one or more mobile devices 100. In an example embodiment, multiple mobile devices 100 would like to access images from a few cameras. For example, if there are one-hundred mobile devices 100 which would like to capture images using one or two cameras 204, 206, then it can be considered that the mobile devices 100 are capturing images using “shared cameras”. The mobile devices 100 request images from the server 208. The server 208 may also be in communication with a secondary server 210 having a processor and memory for storing images. In an example embodiment, images that are stored on the secondary server 210 are deleted from the memory of the server 208.

The server 208 may also be in communication with one or more display devices 211. The display devices 211 are permanently mounted, for example, throughout the venue. The mounted display devices 211 stream images from the cameras 204, 206 in real-time or near-real time. Users can look at the display devices 211 to see the images being captured by the cameras. In an example embodiment, the display of the cameras' images on the display devices 211 is a closed-circuit television (CCTV) system.

It can be appreciated that the servers 208, 210, the cameras 204, 206, the mounted display 211 and the mobile devices 100 are in communication with each other through currently known, or future known, communication means. For example, the cameras 204, 206 and the server 208 are in communication with each other through wired means or wireless means, or both. The servers 208, 210 are in communication with each other through wired means or wireless, or both. The mobile devices 100 are in communication with the server 208 through wireless means.

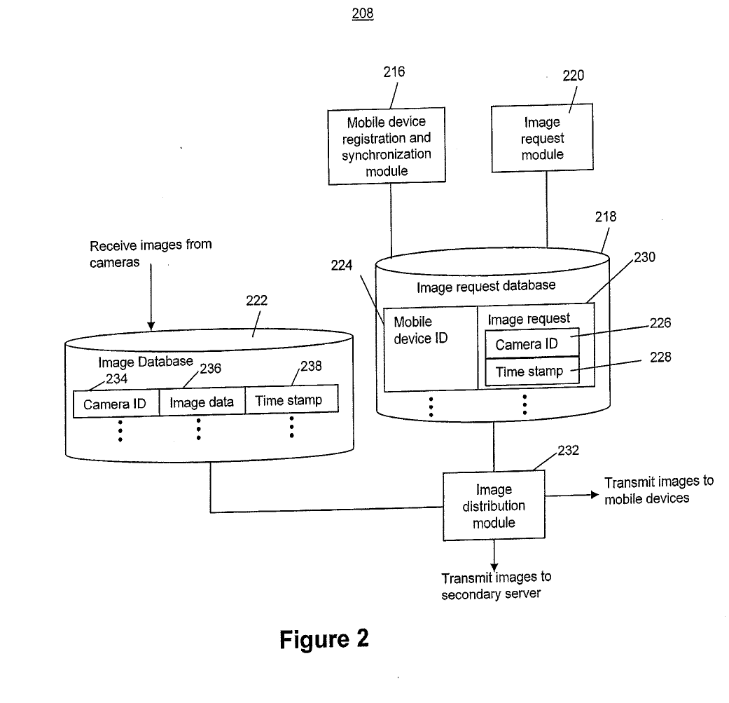

Turning to FIG. 2, an example embodiment of a server 208 is shown. The server 208 includes an image database 222 for storing images from one or more cameras. Image data 236 is tagged or associated with a camera ID 234 and a time stamp 238. The camera ID 234 identifies the camera that captured the image, and the time stamp 238 identifies the date and time that the image was captured.

The server 208 also includes an image request database 218 which organizes and records the requests for images. An image request originates from a mobile device requesting a certain image, as identified by the camera ID and a time stamp. Each image request 230 is associated with a mobile device ID 224. The mobile device ID identifies a mobile device belonging to a user. The image request 230 also includes a camera ID 226 which identifies the camera that captured the desired image, and a time stamp 228 which identifies when the desired image was taken.

The server 208 also includes a mobile device registration and synchronization module 216 which is used to register mobile devices with the server 208. It is also used to synchronize the timing of mobile devices with the server 208. The registration process involves storing the mobile device's information, such as a mobile device ID and user name. In an example embodiment, the mobile device ID is a telephone number. In another example embodiment, the mobile device ID is a combination of numbers or letters, or both, uniquely identifying the mobile device. The mobile device's information may also include contact information including, for example, a phone number, email address and mailing address. In an example embodiment, the mobile device's information also includes associated security information (e.g. password, cryptographic keys, security tokens, etc.) and billing information. Currently known and future known security processes for verifying the identity of a mobile device are applicable to the principles described herein. The mobile device's information, including the mobile device ID, is stored on the server 208.

After a mobile device is registered with the server 208, the mobile device sends image requests to the server 208. The server 208 has an image request module 220 which receives the image requests from the mobile devices. The module 220 stores the requests in the image request database 218.

Continuing with FIG. 2, an image distribution module 232 processes the image requests 230 and obtains the image data 236 to send to the mobile devices that issued the requests. The image distribution module 232 is configured to transmit images to the secondary server 210 for further storage.

In an example embodiment, the image distribution module 232 is also configured to transmit or stream low resolution images to mobile devices. For example, a certain mobile device may be interested in the images originating from a certain camera. The image distribution module 232 can obtain low resolution images based on the high resolution images from the certain camera. The high resolution images are stored in the image database 222 as image data 236. For example, the image distribution module 232 applies image processing to the high resolution images to generate low resolution images, which are then streamed to mobile devices. Based on specific image requests, high resolution images corresponding to those image requests are sent to the mobile devices.

It can be appreciated that various mobile devices can be used with the example embodiments described herein. Example embodiments of applicable electronic devices include pagers, tablets, cellular phones, cellular smart-phones, wireless organizers, personal digital assistants, computers, laptops, handheld wireless communication devices, wirelessly enabled notebook computers, camera devices and the like. Such devices will hereinafter be commonly referred to as “mobile devices” for the sake of clarity. It will however be appreciated that the example embodiments described herein are also suitable for other devices, e.g. “non-mobile” devices.

In an example embodiment, the mobile device is a two-way communication device with advanced data communication capabilities including the capability to communicate with other mobile devices or computer systems through a network of transceiver stations. The mobile device may also have the capability to allow voice communication. Depending on the functionality provided by the mobile device, it may be referred to as a data messaging device, a two-way pager, a cellular telephone with data messaging capabilities, a wireless Internet appliance, or a data communication device (with or without telephony capabilities).

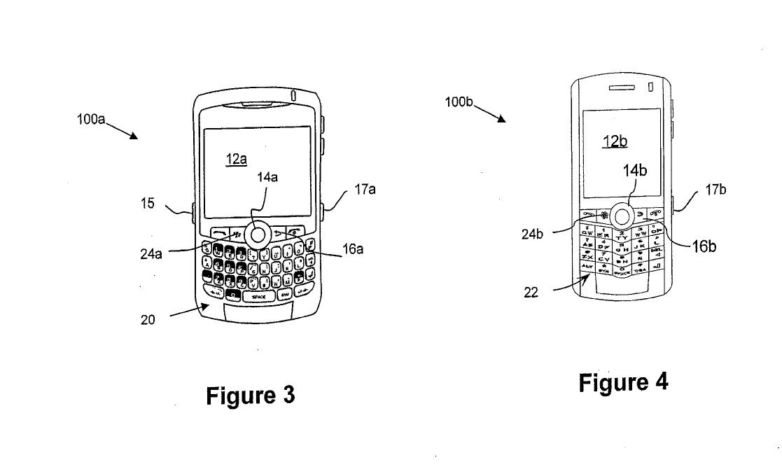

Referring to FIGS. 3 and 4, an example embodiment of a mobile device 100a is shown in FIG. 3, and another example embodiment of a mobile device 100b is shown in FIG. 4. It will be appreciated that the numeral “100” will hereinafter refer to any mobile device 100, including the example embodiments 100a and 100b, those example embodiments enumerated above or otherwise. It will also be appreciated that a similar numbering convention may be used for other general features common between all Figures such as a display 12, a positioning device 14, a cancel or escape button 16, a camera button 17, and a menu or option button 24.

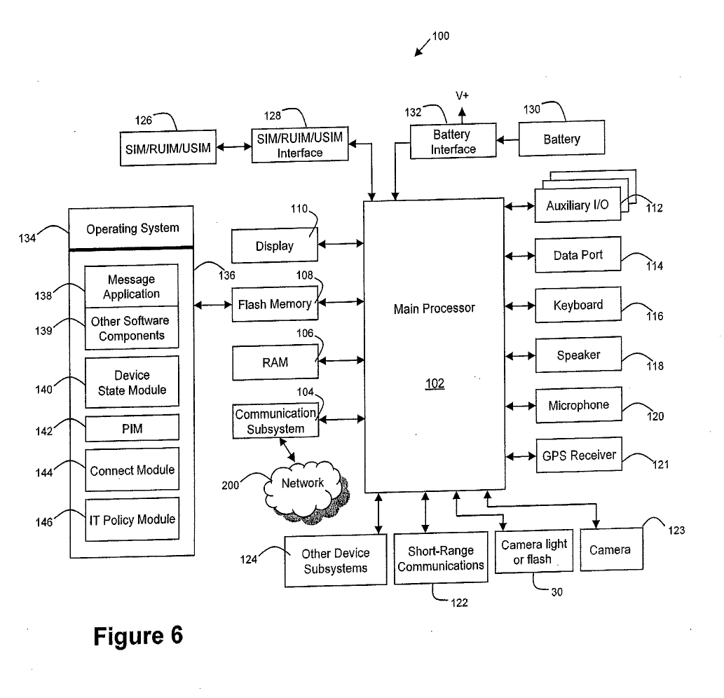

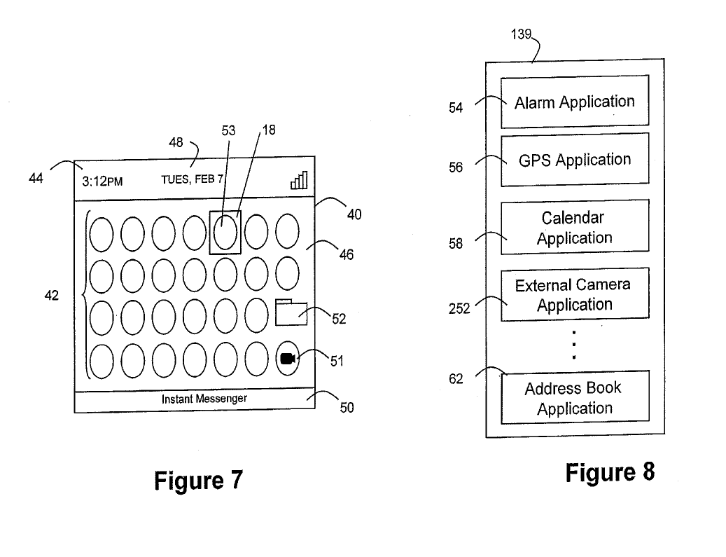

The mobile device 100a shown in FIG. 3 includes a display 12a and the cursor or view positioning device 14 shown in this example embodiment is a trackball 14a. Positioning device 14 may serve as another input member and is both rotational to provide selection inputs to the main processor 102 (see FIG. 6) and can also be pressed in a direction generally toward housing to provide another selection input to the processor 102. Trackball 14a permits multi-directional positioning of the selection cursor 18 (see FIG. 7) such that the selection cursor 18 can be moved in an upward direction, in a downward direction, in a leftward direction, in a rightward direction, and, if desired and/or permitted, in any diagonal direction. The trackball 14a is in this example situated on the front face of a housing for mobile device 100a as shown in FIG. 3 to enable a user to manoeuvre the trackball 14a while holding the mobile device 100a in one hand. The trackball 14a may serve as another input member (in addition to a directional or positioning member) to provide selection inputs to the processor 102 and can preferably be pressed in a direction towards the housing of the mobile device 100a to provide such a selection input.

The display 12 may include a selection cursor 18 that depicts generally where the next input or selection will be received. The selection cursor 18 may include a box, alteration of an icon or any combination of features that enable the user to identify the currently chosen icon or item. The mobile device 100a in FIG. 3 also includes a programmable convenience button 15 to activate a selected application such as, for example, a calendar or calculator. Further, mobile device 100a includes an escape or cancel button 16a, a camera button 17a, a menu or option button 24a and a keyboard 20. The camera button 17 is able to activate photo-capturing functions when pressed preferably in the direction towards the housing. The menu or option button 24 loads a menu or list of options on display 12a when pressed. In this example, the escape or cancel button 16a, the menu option button 24a, and keyboard 20 are disposed on the front face of the mobile device housing, while the convenience button 15 and camera button 17a are disposed at the side of the housing. This button placement enables a user to operate these buttons while holding the mobile device 100 in one hand. The keyboard 20 is, in this example embodiment, a standard QWERTY keyboard.

The mobile device 100b shown in FIG. 4 includes a display 12b and the positioning device 14 in this example embodiment is a trackball 14b. The mobile device 100b also includes a menu or option button 24b, a cancel or escape button 16b, and a camera button 17b. The mobile device 100b as illustrated in FIG. 4, includes a reduced QWERTY keyboard 22. In this example embodiment, the keyboard 22, positioning device 14b, escape button 16b and menu button 24b are disposed on a front face of a mobile device housing. The reduced QWERTY keyboard 22 includes a plurality of multi-functional keys and corresponding indicia including keys associated with alphabetic characters corresponding to a QWERTY array of letters A to Z and an overlaid numeric phone key arrangement.

It will be appreciated that for the mobile device 100, a wide range of one or more positioning or cursor/view positioning mechanisms such as a touch pad, a positioning wheel, a joystick button, a mouse, a touchscreen, a set of arrow keys, a tablet, an accelerometer (for sensing orientation and/or movements of the mobile device 100 etc.), or other whether presently known or unknown may be employed. Similarly, any variation of keyboard 20, 22 may be used. It will also be appreciated that the mobile devices 100 shown in FIGS. 3 and 4 are for illustrative purposes only and various other mobile devices 100 are equally applicable to the following examples. For example, other mobile devices 100 may include the trackball 14b, escape button 16b and menu or option button 24 similar to that shown in FIG. 4 only with a full or standard keyboard of any type. Other buttons may also be disposed on the mobile device housing such as colour coded “Answer” and “Ignore” buttons to be used in telephonic communications. In another example, the display 12 may itself be touch sensitive thus itself providing an input mechanism in addition to display capabilities.

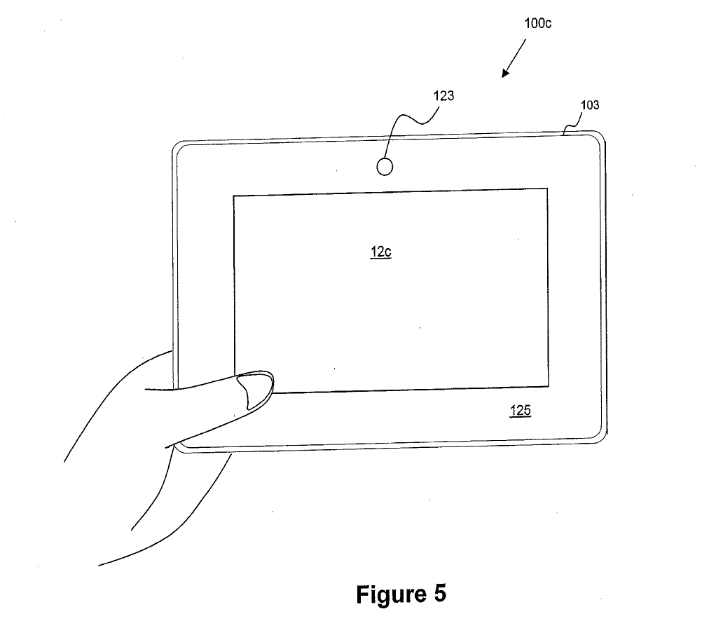

The mobile device 100c shown in FIG. 5 includes a touch-sensitive display 102 and a front-facing camera 123. The touch-sensitive display 103 includes a touch-sensitive non-display area 125 surrounding a touch-sensitive display area 12c, both of which may be capable of receiving inputs in the form of touching. The display area 12c is also considered, more generally, a display 12. The front-facing camera 123 looks towards the user to capture images or videos of the user or scenes behind the user. Although not shown in the figure, it is appreciated that the mobile device 100c may also have a back-facing camera which looks away from the front of the user to give the user's perspective. The mobile device 100c is considered to be a tablet.

To aid the reader in understanding the structure of the mobile device 100, reference will now be made to FIGS. 6 through 8.

Referring first to FIG. 6, shown therein is a block diagram of an example embodiment of a mobile device 100. The mobile device 100 includes a number of components such as a main processor 102 that controls the overall operation of the mobile device 100. Communication functions, including data and voice communications, are performed through a communication subsystem 104. The communication subsystem 104 receives messages from and sends messages to a wireless network 200. In this example embodiment of the mobile device 100, the communication subsystem 104 is configured in accordance with the Global System for Mobile Communication (GSM) and General Packet Radio Services (GPRS) standards, which is used worldwide. Other communication configurations that are equally applicable are the 3G and 4G networks such as EDGE, UMTS and HSDPA, LTE, Wi-Max, etc, and WLAN networks such as WiFi. New standards are still being defined, but it is believed that they will have similarities to the network behaviour described herein, and it will also be understood by persons skilled in the art that the example embodiments described herein are intended to use any other suitable standards that are developed in the future. The wireless link connecting the communication subsystem 104 with the wireless network 200 represents one or more different Radio Frequency (RF) channels, operating according to defined protocols specified for GSM/GPRS communications.

The mobile device 100 can communicate with the server 208 through the wireless network 200.

The main processor 102 also interacts with additional subsystems such as a Random Access Memory (RAM) 106, a flash memory 108, a display 110, an auxiliary input/output (I/O) subsystem 112, a data port 114, a keyboard 116, a speaker 118, a microphone 120, a GPS receiver 121, short-range communications 122, a camera 123, a camera light or flash 30, and other device subsystems 124. The display 110 may be touch-sensitive, as is the case in the example embodiment shown in FIG. 5.

Some of the subsystems of the mobile device 100 perform communication-related functions, whereas other subsystems may provide “resident” or on-device functions. By way of example, the display 110 and the keyboard 116 may be used for both communication-related functions, such as entering a text message for transmission over the network 200, and device-resident functions such as a calculator or task list.

The mobile device 100 can send and receive communication signals over the wireless network 200 after required network registration or activation procedures have been completed. Network access is associated with a subscriber or user of the mobile device 100. To identify a subscriber, the mobile device 100, in an example embodiment, uses a subscriber module component or “smart card” 126, such as a Subscriber Identity Module (SIM), a Removable User Identity Module (RUIM) and a Universal Subscriber Identity Module (USIM). In the example shown, a SIM/RUIM/USIM 126 is to be inserted into a SIM/RUIM/USIM interface 128 in order to communicate with a network. Once the SIM/RUIM/USIM 126 is inserted into the SIM/RUIM/USIM interface 128, it is coupled to the main processor 102. It can be appreciated that the SIM/RUIM/USIM 126 is not used in some mobile devices 100, such as in tablets and e-readers.

The mobile device 100 is a battery-powered device and includes a battery interface 132 for receiving one or more rechargeable batteries 130. In at least some example embodiments, the battery 130 can be a smart battery with an embedded microprocessor. The battery interface 132 is coupled to a regulator (not shown), which assists the battery 130 in providing power V+ to the mobile device 100. Although current technology makes use of a battery, future technologies such as micro fuel cells may provide the power to the mobile device 100.

The mobile device 100 also includes an operating system 134 and software components 136 to 146 which are described in more detail below. The operating system 134 and the software components 136 to 146 that are executed by the main processor 102 are typically stored in a persistent store such as the flash memory 108, which may alternatively be a read-only memory (ROM) or similar storage element (not shown). Those skilled in the art will appreciate that portions of the operating system 134 and the software components 136 to 146, such as specific device applications, or parts thereof, may be temporarily loaded into a volatile store such as the RAM 106. Other software components can also be included, as is well known to those skilled in the art.

The subset of software applications 136 that control basic device operations, including data and voice communication applications, may be installed on the mobile device 100 during its manufacture. Software applications may include a message application 138, a device state module 140, a Personal Information Manager (PIM) 142, a connect module 144 and an IT policy module 146. A message application 138 can be any suitable software program that allows a user of the mobile device 100 to send and receive electronic messages, wherein messages are typically stored in the flash memory 108 of the mobile device 100. A device state module 140 provides persistence, i.e. the device state module 140 ensures that important device data is stored in persistent memory, such as the flash memory 108, so that the data is not lost when the mobile device 100 is turned off or loses power. A PIM 142 includes functionality for organizing and managing data items of interest to the user, such as, but not limited to, e-mail, contacts, calendar events, and voice mails, and may interact with the wireless network 200. A connect module 144 implements the communication protocols that are required for the mobile device 100 to communicate with the wireless infrastructure and any host system, such as an enterprise system, that the mobile device 100 is authorized to interface with. An IT policy module 146 receives IT policy data that encodes the IT policy, and may be responsible for organizing and securing rules such as the “Set Maximum Password Attempts” IT policy.

Other types of software applications or components 139 can also be installed on the mobile device 100. These software applications 139 can be pre-installed applications (i.e. other than message application 138) or third party applications, which are added after the manufacture of the mobile device 100. Examples of third party applications include games, calculators, utilities, external camera applications, etc.

The additional applications 139 can be loaded onto the mobile device 100 through at least one of the wireless network 200, the auxiliary I/O subsystem 112, the data port 114, the short-range communications subsystem 122, or any other suitable device subsystem 124.

The data port 114 can be any suitable port that enables data communication between the mobile device 100 and another computing device. The data port 114 can be a serial or a parallel port. In some instances, the data port 114 can be a USB port that includes data lines for data transfer and a supply line that can provide a charging current to charge the battery 130 of the mobile device 100.

For voice communications, received signals are output to the speaker 118, and signals for transmission are generated by the microphone 120. Although voice or audio signal output is accomplished primarily through the speaker 118, the display 110 can also be used to provide additional information such as the identity of a calling party, duration of a voice call, or other voice call related information.

Turning now to FIG. 7, the mobile device 100 may display a home screen 40, which can be set as the active screen when the mobile device 100 is powered up and may constitute the main ribbon application. The home screen 40 generally includes a status region 44 and a theme background 46, which provides a graphical background for the display 12. The theme background 46 displays a series of icons 42 in a predefined arrangement on a graphical background. In some themes, the home screen 40 may limit the number of icons 42 shown on the home screen 40 so as to not detract from the theme background 46, particularly where the background 46 is chosen for aesthetic reasons. The theme background 46 shown in FIG. 7 provides a grid of icons. It will be appreciated that preferably several themes are available for the user to select and that any applicable arrangement may be used. An example icon may be an external camera icon 51 used to indicate an application for obtaining images from external cameras (e.g. cameras 204, 206). One or more of the series of icons 42 is typically a folder 52 that itself is capable of organizing any number of applications therewithin.

The status region 44 in this example embodiment includes a date/time display 48. The theme background 46, in addition to a graphical background and the series of icons 42, also includes a status bar 50. The status bar 50 provides information to the user based on the location of the selection cursor 18, e.g. by displaying a name for the icon 53 that is currently highlighted.

An application, such as message application 138 may be initiated (opened or viewed) from display 12 by highlighting a corresponding icon 53 using the positioning device 14 and providing a suitable user input to the mobile device 100. For example, message application 138 may be initiated by moving the positioning device 14 such that the icon 53 is highlighted by the selection box 18 as shown in FIG. 7, and providing a selection input, e.g. by pressing the trackball 14b.

FIG. 8 shows an example of the other software applications and components 139 that may be stored and used on the mobile device 100. Only examples are shown in FIG. 8 and such examples are not to be considered exhaustive. In this example, an alarm application 54 may be used to activate an alarm at a time and date determined by the user. A GPS application 56 may be used to determine the location of a mobile device. A calendar application 58 may be used to organize appointments. Another example application is an external camera application 252 that may be used to obtain images from an external camera. Another application shown is an address book 62 that is used to store contact information which may include, for example., an email address, a name, and a phone number.

It will be appreciated that any module or component exemplified herein that executes instructions or operations may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data, except transitory propagating signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the mobile device 100, server 208, or secondary server 210, or accessible or connectable thereto. Any application or module herein described may be implemented using computer readable/executable instructions or operations or processor implemented instructions that may be stored or otherwise held by such computer readable media.

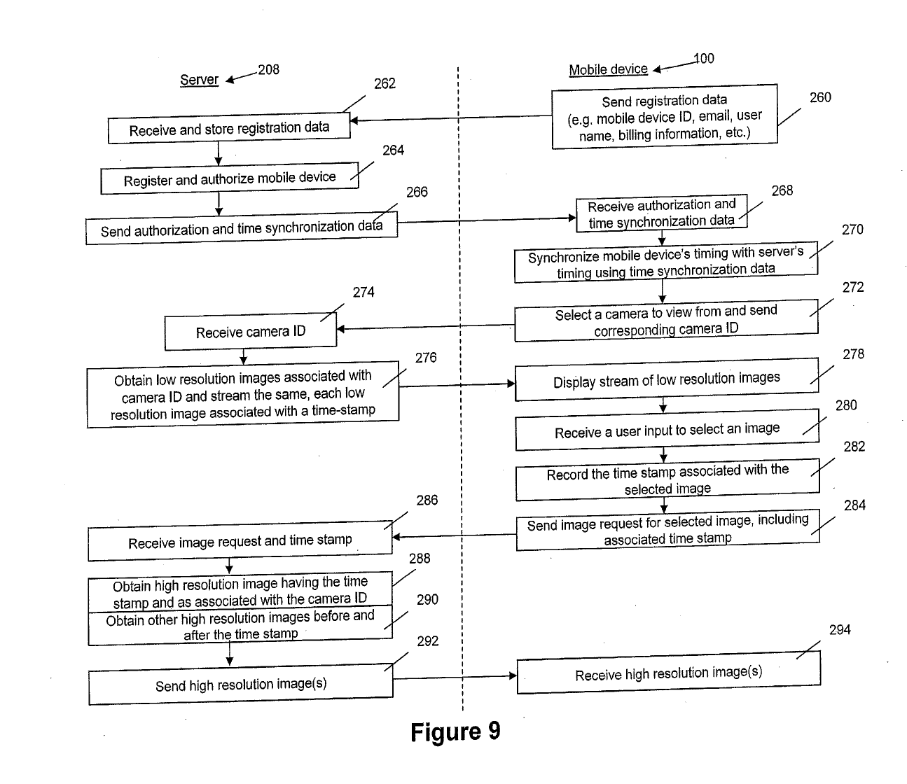

Turning to FIG. 9, example computer executable or processor implemented instructions are provided for a mobile device 100 to obtain an image from a server 208. At block 260, a mobile device 100 sends registration data to a server 208. In an example embodiment, the registration data includes mobile device ID, an e-mail address, and a user name. It may also include billing information where the user is required to pay for the images.

At block 262, the server 208 receives and stores the registration data. The server 208 also registers and authorizes the mobile device 100 to interact with the services of the server 208 (block 264). Various currently known and future known registration and authorization processes are applicable to the principles described herein. The server 208 sends time synchronization data and the authorization to the mobile device 100 (block 266).

In an example embodiment, time synchronization data allows the mobile device 100 to synchronize its own timing with the current timing of the server 208. For example, the time synchronization data includes the timing of the server 208. It can be appreciated that the time or clock setting of the server 208 is different from the time or clock setting of a mobile device 100. Therefore, the server 208 and the mobile device 100 are synchronized.

At block 268, the mobile device receives the authorization and time synchronization data. The mobile device synchronizes its timing with the server's using the time synchronization data (block 270).

Time synchronization can be accomplished in several different ways.

In an example embodiment, the server 208 provides a message to the mobile device 100 that it is following GPS time. For example, the server's clock 214 is following GPS time. The synchronization data includes the message indicating that the server 208 is following GPS time. GPS time refers to GPS time signals or time data provided through GPS satellites. GPS time is used to synchronize multiple devices. After receiving the message, the mobile device 100, which is equipped with a GPS receiver 121, acquires GPS time. In this way, the mobile device 100 and the server 208 are synchronized using the GPS time. The timing on the mobile device 100 would be sufficiently accurate that the mobile device would not need to continuously and constantly reacquire GPS time in order to remain time-synchronized. Instead, in an example embodiment, the mobile device may reacquire GPS time periodically (e.g. every hour or two) in order to ensure that its timing has not drifted too far.

In another example embodiment of synchronization, the server 208 and mobile device 100 exchange their local time values. Local time values herein refer to times that are specific to each device or server. In an example embodiment, the server 208 provides its local time (e.g. the time of the clock 214) to the mobile device as part of the time synchronization data. In another example embodiment, the mobile device provides its local time data to the server. In another example embodiment, both the server 208 and the mobile device 100 exchange their local time data. It is sufficient to synchronize the two entities if at least one of the mobile device and the server has the local time of the other one of the mobile device and the server. This information can be used to determine the relative timing offset between the two entities. For example, the server could send a message to the mobile device requesting the mobile device's local time data, and the mobile device could send a reply including both the mobile device's local time and the amount of processing time spent on the mobile device between reception of the original message and transmission of the reply. This would allow the server to estimate the radio propagation time between the server and the mobile device, and then this propagation time could be used together with the local server time and the received mobile device time to determine the relative timing offset between the two entities.

In another example embodiment, the following method may be used to calculate the relative time difference between the local time of the mobile device and the local time of the server.
The server sends a first message to the mobile device at server time T1.
The mobile device receives the first message at mobile device time T2.
The mobile device transmits a second message to the server at mobile device time T3. The second message includes T3 and either T2 or (T3−T2) (this latter value is the processing time required at the mobile device between the reception of the first message and the transmission of the second message).
The server receives the second message at server time. T4.
The time required for one-way transmission of a message between the server and the mobile device (or vice versa) can be estimated as T5, where:

T5=(T4−T1−(T3−T2))/2

Note that the server already knows T1 and T4, and can extract or calculate T3−T2 from the values included in the second message.
The relative time difference to switch from the mobile device's local time to the server's local time is: T6=T4−T3−T5
The relative time difference to switch from the server's local time to the mobile device's local time is simply the negative of this value: T6′=−T6

In another example embodiment of synchronization, wireless access points (e.g. WiFi hubs or WiFi hot spots) located within the venue could regularly broadcast the server's time. The mobile device 100 could receive this information periodically in order to synchronize its timing with the server 208. For example, the mobile device can receive the server's synchronization data (e.g. the server's time data) every hour or two.

In another example embodiment, external displays 211 are used to show images from the cameras 204, 206, and a portion of the display (or, for example, an adjacent display, not shown) displays timing information of the server 208 which is synchronized with the displayed video stream. The timing information can take the form of a bar code. Examples of bar codes include 1-D bar codes, 2D bar codes and QR bar codes. A user can then acquire this displayed timing information by using the mobile device to scan or take a picture of the displayed bar code. The mobile device therefore knows or has the server timing at the point in time when this timing information was acquired, and the mobile device can then synchronize its timing accordingly. For example, the timing information in the bar code is the timing of the server 208, and this information can be compared to the mobile device's time recorded when it captured or scanned the bar code. This comparison of time data is used to synchronize the mobile device's timing.

As will be discussed in greater detail below, the mobile device 100 and the server 208 use the synchronization data to determine how an image captured by an external camera is related to the time at which a user selects a button on their mobile device to obtain that image. The above example embodiments of synchronization can be used with other example embodiments in the present application describing how a mobile device obtains an image captured by an external camera.

Continuing with FIG. 9, at block 272, a selection of a certain camera is received by the mobile device, indicating that the user desires to view the images from the certain camera. In an example embodiment, the user enters in a camera ID to the mobile device to select the certain camera. In another example embodiment, the mobile device displays the locations of multiple cameras and their corresponding points of view, and the user can select the certain camera through a GUI. The camera ID corresponding to the camera is sent to the server. After the server 208 receives the camera ID (block 274), it obtains low resolution images associated with the camera ID and streams the same to the mobile device (block 276). The low resolution images can be obtained by using currently known or future known image processing techniques to convert an image to a lower resolution image. This is also referred to as image compression.

In an example embodiment, each low resolution image is associated with a time stamp and both the image and the time stamp are sent to the mobile device. If a time stamp is sent with the associated image to the mobile device, the initial time synchronization operations at blocks 266, 268 and 270 are not required. In other words, the time stamps sent with each of the low resolution images, per block 276, can be used as synchronization data to synchronize the timing of the mobile device.

The time stamp can take different forms. In an example embodiment, the time stamp has the form HH:MM:SS:FF (i.e. Hour, Minute, Second, Fraction of a second). In another example embodiment, the time stamp may only include a subset of these values, such as SS:FF, where the larger granularity numbers would not be required since the time stamp of the image request would normally be received by the server with a minimal delay. For example, if a server receives an image request from a mobile device with a delay of less than 30 seconds since that image request was generated by the end user, then HH:MM values may not need to be included within the time stamp of the image request. In yet another example embodiment, the time stamp has the form of a frame number within a video stream of images (e.g. an MPEG file). In an example embodiment, the time stamp is a unique identifier associated with a particular image so that both the server and mobile device can ensure they are both referring to the same image.

At block 278, the mobile device displays the stream of low resolution images, for example on display 12, or display 110. It can be appreciated that low resolution images are being streamed since the data size is smaller. The smaller data size allows the low resolution images to be streamed at a higher data-transfer rate. However, there is likely to be some delay in the streamed images, such that the streamed images lag in time compared to the real-life events being captured. The lag or delay is reduced by streaming low resolution images, rather than streaming the corresponding high resolution images.

At block 280, while the user is viewing the stream of low resolution images on the mobile device 100, when the user sees an image that he or she would like to capture, the user presses a button or key on mobile device 100, designated for selecting an image, to take a picture of the image. In other words, the mobile device 100 receives an input from the user to select an image. At block 282, the mobile device records the time stamp associated with the selected image. In an example embodiment, the mobile device notes the exact time, for example, within an accuracy of a fraction of a second, that the user input was received and generates a request for the image corresponding to the exact time.

At block 284, the mobile device sends the image request for the selected image, which includes the associated time stamp. The image request does not need to be sent in real time because the mobile device and the server 208 have their time synchronized. In other words, the time stamp marks the selected image, and not the time that the image request is received by the server 208. The image request can be sent at a later time to the server 208.

At block 286, the server 208 receives the image request, including the time stamp. The server 208 obtains the high resolution image having the same time stamp and the same camera ID (block 288). In an example embodiment, at block 290, multiple high resolution images are obtained that were captured by the camera within a predetermined time interval before or after the time stamp, or both. For example, images captured one second before and after the time stamp are obtained. At block 292, the high resolution image, or images, are sent to the mobile device 100, and at block 294 they are received by the mobile device 100.

In an example embodiment, the requested image is stored by the server 208 in memory on the server 208 or on the secondary server 210. At a later time, the user retrieves the requested image from the server 208, or secondary server 210, using the mobile device 100 or some other computing device used by the user.

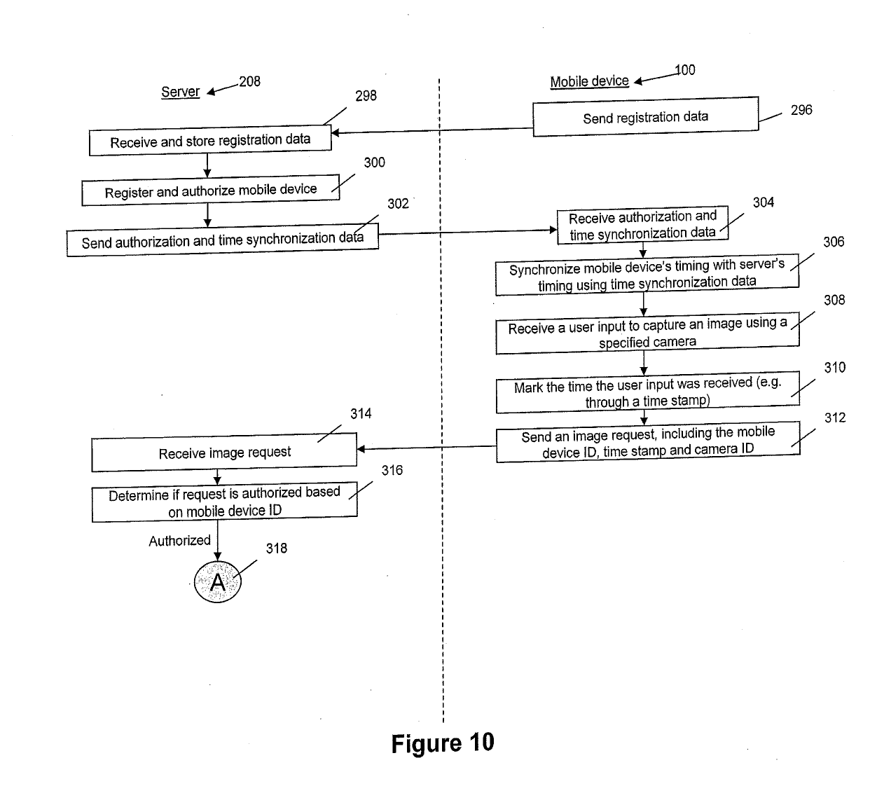

In another example embodiment, the images are streamed to a mounted display screen 211 for display to the public. A user can view the images from a camera in real time or near-real time. A user can also be looking physically at the actual scene or environment at which a camera is viewing. In this way, the user able to see the scene being imaged without using the mobile device 100. Therefore, low resolution images do not need to be streamed to the mobile device 100. This greatly reduces the amount of data being transferred to and from the mobile device 100. Such an example embodiment is described with respect to FIGS. 10 to 13.

Turning to FIG. 10, an example embodiment of computer executable or processor implemented instructions are provided for obtaining images. At block 296, the mobile device sends registration data. At block 298, the server 208 receives and stores the registration data. At block 300, the server registers and authorizes the mobile device. It sends the authorization and time synchronization data to the mobile device (block 302). At block 304, the mobile device receives the authorization and time synchronization data. At block 306, the mobile device uses the time synchronization data to synchronize the mobile device's time with the server's time.

Although not shown, in an example embodiment, the server 208 is streaming images from one or more cameras to the display device 211. A user can view the images from the cameras 204, 206 in real-time or near real-time by watching the display device 211. In another example embodiment, the user can directly view the physical scene or environment which is being imaged by the cameras 204, 206. For example, if the cameras are imaging a roller coaster, the live images from the roller coaster are displayed on the display device 211. Alternatively, the user is looking directly at the physical roller coaster, rather than the display device 211.

At the desired moment that the user wishes to capture an image from a certain camera, the user provides an input to the mobile device 100 to capture an image from the certain camera. For example, the user presses a button or key on mobile device 100, designated for selecting an image, to take a picture of the image. In other words, at block 308, the mobile device 100 receives an input from the user to capture an image using a specified camera. At block 310, the mobile device marks the time that the user input was received, for example, using a time stamp. At block 312, the mobile device sends an image request, which includes the mobile device ID, the time stamp, and the camera ID.

At block 314, the server 208 receives the image request. In an example embodiment, the server 208 determines if the image request originates from an authorized entity by verifying the mobile device ID (block 316). If the mobile device is authorized, the process continues. Otherwise, the process stops.

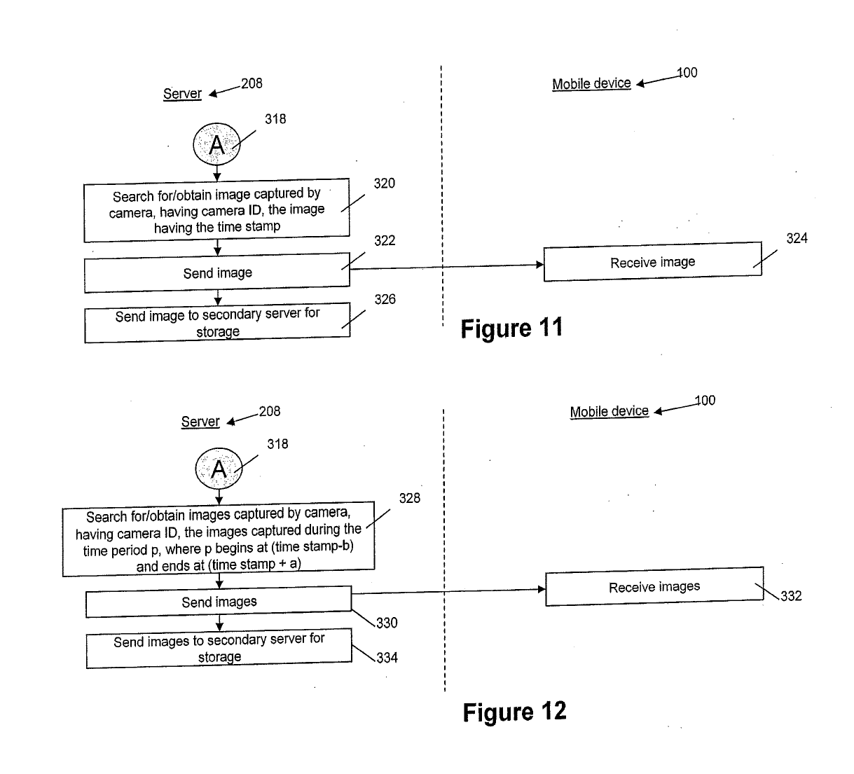

The process continues to FIG. 11 or FIG. 12, as marked by the “A” in the circle 318.

Turning to FIG. 11, an example embodiment of computer executable or processor implemented instructions are provided, which continue from block 316. Referring to FIG. 11, at block 320, the server 208 searches for, or obtains, the image captured by the camera as identified by the camera ID and the time stamp. At block 322, the server 208 sends the image to the mobile device, and the mobile device receives the image (block 324). In an example embodiment, the image is sent to the secondary server for storage (block 326). For example, the mobile device 100 retrieves another copy of the requested image from the server 208 or secondary server 210 at a later time.

Turning to FIG. 12, another example embodiment of computer executable or processor implemented instructions are provided in continuation of block 316, as marked by the circle 318. At block 328, the server 208 searches for or obtains images captured by the camera, having the camera ID. Furthermore, the images that fall within a time period p are also obtained. The time period p begins at the (time stamp−b) and ends at (time stamp+a), whereby b and a are values of time in seconds. For example, a buffer value b is two seconds, and the buffer value a is one second. The buffer value b is, for example, larger than the buffer value a because it is expected that a user will press the button or key on mobile device 100, designated for selecting an image, to take a picture of the image, after the desired image has been shown. In an example embodiment, the buffer values a and b are defined by the user and are transmitted from the mobile device 100 to the server 208.

The set of images captured within the time period p are sent to mobile device (block 330) and are received by the mobile device (block 332). In other words, even if the user does not press the button or key at exactly the desired time as the image being captured, the other pictures within the defined time period p are likely to include the desired image.

The images are stored on the secondary server 210, where they can be retrieved at a later time by the user (block 334).

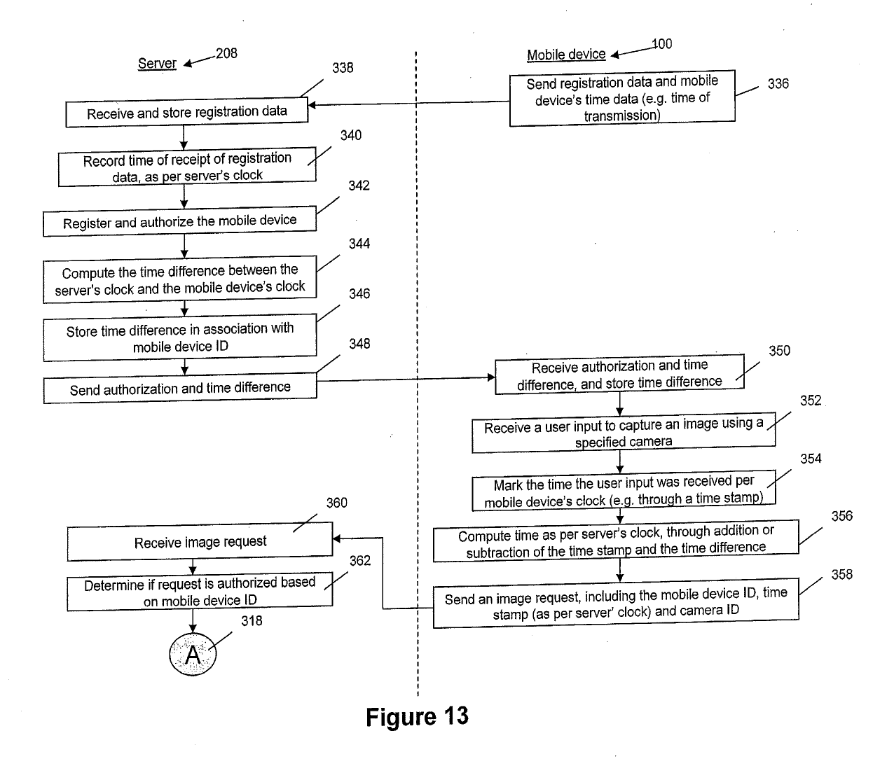

Turning to FIG. 13, an example embodiment of computer executable or processor implemented instructions are provided for obtaining an image. In particular, a time difference between the server 208 and the mobile device 100 is computed to synchronize the server and the mobile device. At block 336, the mobile device sends registration and the mobile device's time data, according to the mobile device's clock. In an example embodiment, the time data is the time of transmission of the registration data, according to the mobile device's clock. At block 338, the server receives and stores this information. At block 340, the server records the time of receipt of the registration data, according to the server's own clock. It can be appreciated that the timing between the server and the mobile device are not the same and thus, it is desirable to have them synchronized. At block 342, the server registers and authorizes the mobile device. At block 344, the server computes the time difference between the server's clock and the mobile device's clock. In an example embodiment, the time difference≅time of receipt (according to the server's clock)−time of transmission (according to the mobile device's clock). At block 346, the time difference is stored in association with the mobile device ID. At block 348, the authorization and the time difference are sent to the mobile device.

At block 350, the mobile device receives and stores the time difference and the authorization. In an example scenario, the user is directly viewing the actual real-life events which are being imaged by one or cameras 204, 206, or is viewing a mounted display screen 211 which displays the imaged events in real-time or near real-time. When the user sees an event or an image he or she desires to capture, the user presses a button or key on mobile device 100, designated for selecting an image, to take a picture of the desired image. In other words, at block 352, the mobile device receives a user input to capture an image using a specified external camera. The mobile device marks the time that the user input was received according to the mobile device's clock (block 354). This can be represented as time stamp_{mobile device}. In an example embodiment, the mobile device computes the time stamp from the server's clock perspective through addition or subtraction of time stamp_{mobile device} and the time difference (block 356). For example, time stampₛₑᵣᵥₑᵣ==time stamp_{mobile device}−time difference. The mobile device sends an image request, which includes the mobile device ID, the time stampₛₑᵣᵥₑᵣ, and the camera ID (block 358).

At block 360, the server receives the image request. In an example embodiment, the server determines if the request is authorized based on the mobile device ID (block 362). If authorized the process continues to the operations described in FIGS. 11 and 12, as noted by the “A” in the circle 318. The computed time stamp, according to the server's clock, is used to identify the desired image or images.

In the example embodiment of FIG. 13, the images of the camera are time stamped according to the server's clock in real-time or near real-time.

In another example embodiment, not shown, the mobile device sends the time stamp_{mobile device}, the mobile device ID and the camera ID in the image request to the server. The server then computes time stampₛₑᵣᵥₑᵣ using the time difference that is stored in association with the mobile device ID. In other words, the mobile device does not compute the time stampₛₑᵣᵥₑᵣ.

The example embodiments described with respect to FIGS. 10 to 13 allow a user to capture the desired image using an external camera according to their own control. Some time later, the user is able to send the image request to the server 208 to retrieve or obtain the desired image. This is made possible by the synchronization process that took place, for example, during the registration process.

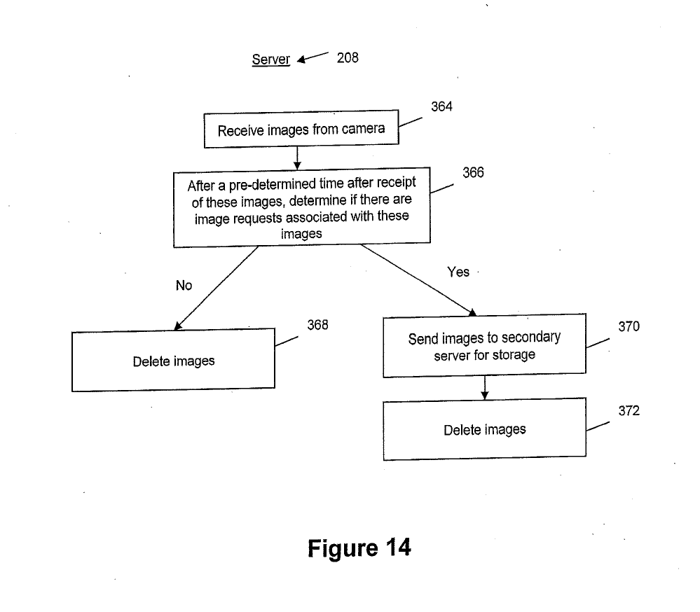

Turning to FIG. 14, an example embodiment of computer executable or processor implemented instructions are provided for the server 208 to manage the images being stored thereon. It is recognized that image data is large. When there are multiple cameras, and streaming images from the cameras are being stored on the server 208, the amount of data quickly builds. The image data on the server 208 may be too great for its memory or storage capabilities. Therefore, in an example embodiment, image data is eventually deleted.

Referring to FIG. 14, at block 364, the server 208 receives images from one or more cameras and stores them in the image database 222. The images can be photographs or video data, or both. At block 366, after a pre-determined amount of time after receipt of these images, the server determines if image requests have been received in association with these images. If not, these images are deleted from the server's memory (block 368). If image requests have been received within the pre-determined amount of time, at block 370, the server 208 sends these images to the secondary server 210 for storage. At block 372, these images are then deleted from the, server's memory (e.g. from. database 222).

In this way, the storage or memory of the server 208 is managed to allow more room to store newer images. The older and unwanted images are deleted. The requested images are stored in the secondary server 210, which can be retrieved later by a user.

This also addresses privacy issues. For example, unless an image is requested within a certain period of time, it is deleted to protect the privacy of the people who are in the images. In an example embodiment, the pre-determined amount of time is one minute.

In another example embodiment, it is recognized that a user can be limited to access only certain cameras depending on their location. For example, the user must be located nearby a certain camera to access the certain camera. This prevents the user from viewing and acquiring images from other external cameras when the user is located far away from such cameras. This in turn supports the control of privacy.

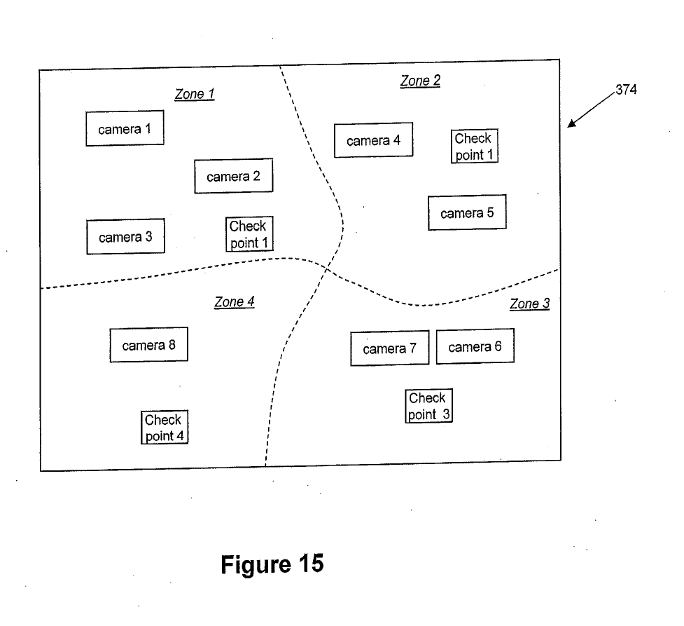

Turning to FIG. 15, an example map 374 shows the locations of external cameras, noted as ‘camera 1’, ‘camera 2’, . . . , and ‘camera 8’. The map 374 is also divided into different zones, i.e. ‘Zone 1’, ‘Zone 2’, ‘Zone 3’ and ‘Zone 4’, and each zone identifies a grouping of cameras. For example, in ‘Zone 1’, there are located ‘camera 1’, ‘camera 2’ and ‘camera 3’. In ‘Zone 4’ there is located ‘camera 8’. Each zone also has a check point. For example, in ‘Zone 1’ there is ‘Check point 1’ and in ‘Zone 2’ there is ‘Check point 2’.

A user can access the cameras of a certain zone after the user verifies he or she is located within the certain zone. In an example embodiment, the position of the mobile device 100 can be tracked using the GPS receiver 121, and this position information can be checked against the area of the certain zone.

In another example embodiment, a user verifies that he or she is located within a certain zone by using the mobile device 100 to check-in at a check point in the certain zone. For example, if the user wants to access the images of ‘camera 8’ in ‘Zone 4’, the user needs to use his or her mobile device 100 to check-in at ‘Check point 4’. In an example embodiment, the check point is a barcode (e.g. 1D barcode, 2D barcode, QR code, etc.) that includes the identity of the zone, also referred to as the zone ID. The barcode can be displayed on a mount located within a zone. In another example embodiment, the check point is at least one of a radio frequency identification (RFID) tag and a device capable of reading RFID tags. In another example, the check point is at least one of an unpowered near field communications (NFC) tag and a NFC device capable of reading NFC tags. The RFID tags or NFC tags store the zone ID and can transfer the same to a mobile device 100. Where the check point is a RFID reader or a NFC reader, the check point reads the mobile device ID from the mobile device and sends the mobile device ID and zone ID to the server 208 to verify the mobile device's location.

In another example embodiment, the mobile device's access to or authorization for the cameras in a particular zone is removed or expires after a particular event occurs. Example events could include but are not limited to: a certain period of time has elapsed since the device registered for the particular zone; a positioning mechanism (such as GPS) determines that the mobile device is no longer within the particular zone; and the mobile device can no longer receive a wireless signal from a wireless access point (e.g. WiFi access point or WiFi hot spot), where the wireless access point is located within the particular zone.

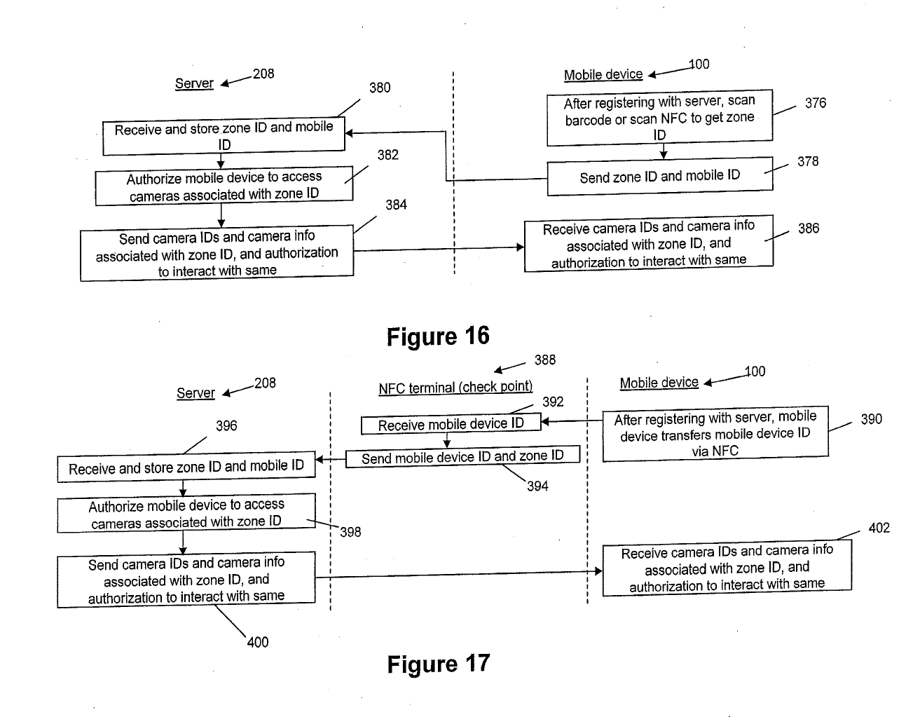

Turning to FIG. 16, in an example embodiment, the check point is at least one of a barcode, an RFID tag, and a NFC tag. It is appreciated that the mobile device 100 is equipped with the hardware and the software to accordingly scan the barcode, the RFID tag, or the NFC tag.

At block 376, after registering with the sever 208, the mobile device 100 scans the barcode or the tag to obtain the zone ID. The mobile device 100 is physically located at the check point within the zone (having the zone ID) in order to obtain the zone ID. At block 378, the mobile device sends the zone ID and mobile device ID to the server 208, and the server receives and stores this information (block 380). At block 382, the server authorizes the mobile device to access the cameras associated with the zone ID. At block 384, the server sends the camera IDs and camera information associated with the zone ID, along with the authorization to interact with the cameras to the mobile device. At block 386, the mobile device receives this information, and uses this information to access the cameras within the specified zone ID to obtain images. For example, the images are obtained using the methods described herein.

In an example embodiment, the camera information includes streaming low resolution images from the cameras associated with the zone ID.

In another example embodiment, the check point is an RFID device reader or an NFC device reader 388 which is in communication with the server 208. Turning to FIG. 17, example embodiment computer executable or processor implemented instructions are provided for verifying the location of a mobile device with respect to one or more external cameras.

At block 390, after registering with the server, the mobile device transfers its mobile device ID via NFC or RFID. The mobile device includes a RFID tag or an NFC tag which can transmit the mobile device ID to the reader 388. The mobile device is physically located at the check point within the zone in order to transfer this information. At block 392, the reader 388 receives the mobile device ID. At block 394, the reader 388 sends the mobile device ID and the zone ID associated with the zone that it is located within to the server 208.

At block 396, the server 208 receives and stores the zone ID and the mobile device ID. At block 398, the server authorizes the mobile device to access cameras associated with the zone ID. At block 400, the server sends the camera IDs and camera information associated with the zone ID, along with the authorization to interact with the cameras to the mobile device. At block 402, the mobile device receives this information, and uses this information to access the cameras within the specified zone ID to obtain images. For example, the images are obtained using the methods described herein.

In a more general example embodiment, a method is provided for a mobile device to obtain an image from an external camera. The method is performed by the mobile device and the method includes: at least one of sending or receiving synchronization data, respectively, to or from a server; receiving at least one low resolution version of the image captured by the external camera; receiving an input to select a certain low resolution image; generating a time stamp associated with the low resolution image, generated using the synchronization data; sending an image request for the image, including the time stamp, to the server; and receiving a high resolution version of the image.

In another example embodiment aspect, if the synchronization data is received, the synchronization data includes a local time of the server. In another example embodiment aspect, if the synchronization data is received, the synchronization data includes a message that the server uses GPS time, and the method further including the mobile device synchronizing its time to the GPS time. In another example embodiment aspect, the mobile device receives the synchronization data concurrently with the stream of low resolution images. In another example embodiment aspect, if the synchronization data is sent to the server, the synchronization data includes a local time of the mobile device. In another example embodiment aspect, the method further includes the mobile device sending registration data to the server, and the mobile device receiving an authorization with the synchronization data. In another example embodiment aspect, the registration data includes a mobile device ID, an email address, and a user name. In another example embodiment aspect, after sending the image request, at least one other high resolution image is received, the at least one other high resolution image captured by the external camera within a predetermined time period before or after the time stamp. In another example embodiment aspect, the method further includes: scanning a barcode or scanning a radio frequency identification (RFID) tag to obtain a zone ID; sending the zone ID and a mobile ID to the server; receiving at least one camera ID identifying the external camera, the stream of low resolution images associated with the camera ID, and an authorization to obtain images associated with the camera ID; and wherein the zone ID identifies a zone in which the external camera is located and the barcode or the RFID tag are located within the zone. In another example embodiment aspect, the method further includes: sending a mobile device ID to a check point terminal through a near field communications (NFC) tag on the mobile device, the check point terminal including an NFC reader; receiving from the server at least one camera ID identifying the external camera, the stream of low resolution images associated with the camera ID, and an authorization to obtain images associated with the camera ID; and wherein the check point terminal and the external camera are both located in a zone. In another example embodiment aspect, the method further includes the mobile device displaying at least one low resolution version of the image. In another example embodiment aspect, the image request is for the high resolution version of the image.

In another more general example embodiment, a method is provided for a mobile device to obtain an image from an external camera. The method is performed by the mobile device and the method includes: at least one of sending or receiving synchronization data, respectively, to or from a server; receiving an input to indicate the image desired to be obtained, the image captured by the external camera; generating a time stamp marking when the input was received, the time stamp generated using the synchronization data; sending an image request to the server, the image request including the time stamp; and receiving the image from the server.

In another example embodiment aspect, if the synchronization data is received, the synchronization data includes a local time of the server. In another example embodiment aspect, if the synchronization data is received, the synchronization data includes a message that the server uses GPS time, and the method further including the mobile device synchronizing its time to the GPS time. In another example embodiment aspect, the method further includes receiving at least one low resolution version of the image concurrently with the synchronization data; and displaying the at least one low resolution version of the image; wherein the image received from the server is a high resolution version of the image. In another example embodiment aspect, if the synchronization data is sent to the server, the synchronization data includes a local time of the mobile device. In another example embodiment aspect, the method further includes the mobile device sending registration data to the server, and the mobile device receiving an authorization with the synchronization data. In another example embodiment aspect, the registration data includes a mobile device ID, an email address, and a user name. In another example embodiment aspect, after sending the image request, at least one other image is received, the at least one other image captured by the external camera within a predetermined time period before or after the time stamp. In another example embodiment aspect, the method further includes: scanning a barcode or scanning a radio frequency identification (RFID) tag to obtain a zone ID; sending the zone ID and a mobile ID to the server; receiving at least one camera ID identifying the external camera and an authorization to obtain images associated with the camera ID; and wherein the zone ID identifies a zone in which the external camera is located and the barcode or the RFID tag are located within the zone. In another example embodiment aspect, the method further includes: sending a mobile device ID to a check point terminal through a near field communications (NFC) tag on the mobile device, the check point terminal including an NFC reader; receiving from the server at least one camera ID identifying the external camera and an authorization to obtain images associated with the camera ID; and wherein the check point terminal and the external camera are both located in a zone.

In another more general example embodiment, a method is provided for providing an image to a mobile device. The method is performed by a server and the method includes: at least one of sending or receiving synchronization data, respectively, to or from the mobile device; receiving multiple images, including the image, from an external camera, each one of the multiple images associated with a time stamp; receiving an image request for the image from the mobile device, the image request including a time stamp generated using the synchronization data; obtaining the image from the multiple images identified using the time stamp received in the image request; and sending the image to the mobile device.

In another example embodiment aspect, if the synchronization data is sent, the synchronization data includes a local time of the server. In another example embodiment aspect, if the synchronization data is sent, the synchronization data includes a message that the server uses GPS time. In another example embodiment aspect, if the synchronization data is received, the synchronization data includes a local time of the mobile device. In another example embodiment aspect, the method further includes receiving registration data from the mobile device; and after registering the mobile device, sending an authorization and the synchronization data to mobile device. In another example embodiment aspect, the method further includes, after receiving the image request, determining if the mobile device is authorized to obtain the image using the registration data. In another example embodiment aspect, the received multiple images are high resolution images and the method further includes: obtaining multiple low resolution images corresponding to the received multiple images; sending a stream of the multiple low resolution images to the mobile device, including the associated time stamps; and after receiving the image request, obtaining and sending the image to the mobile device, the image being a high resolution image. In another example embodiment aspect, the associated time stamps are the synchronization data sent to the mobile device. In another example embodiment aspect, the method further includes, after receiving the image request, obtaining and sending at least one other image to the mobile device, the at least one other image captured by the external camera within a predetermined time period before or after the time stamp. In another example embodiment aspect, the method further includes: receiving a zone ID from the mobile device; generating an authorization for the mobile device to obtain images associated with the external camera, the external camera identified by a camera ID; and sending the authorization and the camera ID to the mobile device; wherein the zone ID identifies a zone in which the external camera is located.

The steps or operations in the flow charts described herein are just for example. There may be many variations to these steps or operations without departing from the spirit of the invention or inventions. For instance, the steps may be performed in a differing order, or steps may be added, deleted, or modified.

It will be appreciated that the particular example embodiments shown in the figures and described above are for illustrative purposes only and many other variations can be used according to the example embodiments described. Although the above has been described with reference to certain specific example embodiments, various modifications thereof will be apparent to those skilled in the art as outlined in the appended claims.

1. A method performed by a mobile device to obtain an image from an external camera, comprising:
at least one of sending or receiving synchronization data, respectively, to or from a server;
receiving at least one low resolution version of an image captured by the external camera;
receiving an input to select one of the at least one image;
generating a time stamp associated with the selected image, using the synchronization data;
sending an image request for the image, including the time stamp, to the server; and
receiving a high resolution version of the image.

2. The method of claim 1 wherein if the synchronization data is received, the synchronization data comprises a local time of the server.

3. The method of claim 1 wherein if the synchronization data is received, the synchronization data comprises a message that the server uses GPS time, and the method further comprising the mobile device synchronizing its time to the GPS time.

4. The method of claim 1 wherein the mobile device receives the synchronization data concurrently with the at least one low resolution version of the image.

5. The method of claim 1 wherein if the synchronization data is sent to the server, the synchronization data comprises a local time of the mobile device.

6. The method of claim 1 further comprising the mobile device sending registration data to the server, and the mobile device receiving an authorization with the synchronization data.

7. The method of claim 6 wherein the registration data comprises a mobile device ID, an email address, and a user name.

8. The method of claim 1 wherein, after sending the image request, at least one other high resolution image is received, the at least one other high resolution image captured by the external camera within a predetermined time period before or after the time stamp.

9. The method of claim 1 further comprising:
scanning a barcode or scanning a radio frequency identification (RFID) tag to obtain a zone ID;
sending the zone ID and a mobile ID to the server;
receiving at least one camera ID identifying the external camera, the at least one low resolution version of the image associated with the camera ID, and an authorization to obtain images associated with the camera ID; and
wherein the zone ID identifies a zone in which the external camera is located and the barcode or the RFID tag are located within the zone.

10. The method of claim 1 further comprising:
sending a mobile device ID to a check point terminal through a near field communications (NFC) tag on the mobile device, the check point terminal comprising an NFC reader;
receiving from the server at least one camera ID identifying the external camera, the at least one low resolution version of the image associated with the camera ID, and an authorization to obtain images associated with the camera ID; and
wherein the check point terminal and the external camera are both located in a zone.

11. The method of claim 1 further comprising the mobile device displaying the at least one low resolution version of the image.

12. The method of claim 1 wherein the image request is for the high resolution version of the image.

13. A method performed by a mobile device to obtain an image from an external camera, comprising:
at least one of sending or receiving synchronization data, respectively, to or from a server;
receiving an input to indicate the image desired to be obtained, the image captured by the external camera;
generating a time stamp marking when the input was received, using the synchronization data;
sending an image request to the server, the image request comprising the time stamp;
receiving the image from the server.

14. The method of claim 13 wherein if the synchronization data is received, the synchronization data comprises a local time of the server.

15. The method of claim 13 wherein if the synchronization data is received, the synchronization data comprises a message that the server uses GPS time, and the method further comprising the mobile device synchronizing its time to the GPS time.

16. The method of claim 13 wherein the method further comprises receiving at least one low resolution version of the image concurrently with the synchronization data; and displaying the at least one low resolution version of the image; wherein the image received from the server is a high resolution image.

17. The method of claim 13 wherein if the synchronization data is sent to the server, the synchronization data comprises a local time of the mobile device.

18. The method of claim 13 further comprising the mobile device sending registration data to the server, and the mobile device receiving an authorization with the synchronization data.

19. The method of claim 18 wherein the registration data comprises a mobile device ID, an email address, and a user name.

20. The method of claim 13 wherein, after sending the image request, at least one other image is received, the at least one other image captured by the external camera within a predetermined time period before or after the time stamp.

21. The method of claim 13 further comprising:
scanning a barcode or scanning a radio frequency identification (RFID) tag to obtain a zone ID;
sending the zone ID and a mobile ID to the server;
receiving at least one camera ID identifying the external camera and an authorization to obtain images associated with the camera ID; and
wherein the zone ID identifies a zone in which the external camera is located and the barcode or the RFID tag are located within the zone.

22. The method of claim 13 further comprising:
sending a mobile device ID to a check point terminal through a near field communications (NFC) tag on the mobile device, the check point terminal comprising an NFC reader;
receiving from the server at least one camera ID identifying the external camera and an authorization to obtain images associated with the camera ID; and
wherein the check point terminal and the external camera are both located in a zone.

23. A method performed by a server for providing an image to a mobile device, comprising:
at least one of sending or receiving synchronization data, respectively, to or from the mobile device;
receiving multiple images, including the image, from an external camera, each one of the multiple images associated with a time stamp;
receiving an image request for the image from the mobile device, the image request including a time stamp generated using the synchronization data;
obtaining the image from the multiple images identified using the time stamp received in the image request; and
sending the image to the mobile device.

24. The method of claim 23 wherein if the synchronization data is sent, the synchronization data comprises a local time of the server.

25. The method of claim 23 wherein if the synchronization data is sent, the synchronization data comprises a message that the server uses GPS time.

26. The method of claim 23 wherein if the synchronization data is received, the synchronization data comprises a local time of the mobile device.

27. The method of claim 23 further comprising receiving registration data from the mobile device; and after registering the mobile device, sending an authorization and the synchronization data to mobile device.

28. The method of claim 27 further comprising, after receiving the image request, determining if the mobile device is authorized to obtain the image using the registration data.

29. The method of claim 23 wherein the received multiple images are high resolution images and the method further comprises:
obtaining multiple low resolution images corresponding to the received multiple images;
sending at least one low resolution version of the image to the mobile device, including the associated time stamps; and
after receiving the image request, obtaining and sending a high resolution version of the image to the mobile device.

30. The method of claim 29 wherein the associated time stamps are the synchronization data sent to the mobile device.

31. The method of claim 23 further comprising, after receiving the image request, obtaining and sending at least one other image to the mobile device, the at least one other image captured by the external camera within a predetermined time period before or after the time stamp.

32. The method of claim 23 further comprising:
receiving a zone ID from the mobile device;
generating an authorization for the mobile device to obtain images associated with the external camera, the external camera identified by a camera ID;
sending the authorization and the camera ID to the mobile device; and
wherein the zone ID identifies a zone in which the external camera is located.
